(19) United States
(12) Patent Application Publication
(10) Pub. No.: US 2022/0184999 A1
(43) Pub. Date: Jun. 16, 2022

(54) ADHESIVE AND APPLICATOR HOLDER

(71) Applicant: Tracy Joanna Lai, Vancouver (CA)

(72) Inventor: Tracy Joanna Lai, Vancouver (CA)

(21) Appl. No.: 17/117,606

(22) Filed: Dec. 10, 2020

(51) Int. Cl. B43M 99/00; B43M 11/06

(52) U.S. Cl. CPC B43M 99/00; B43M 11/06

(57) ABSTRACT

An adhesive material holder further being configured to retain applicators thereof for access by a user. The present invention includes an adhesive retention member that includes a first compartment and a second compartment each being annular in shape having an interior volume. The first compartment and second compartment are formed in the upper surface of the adhesive retention member and have an interior volume configured to retain adhesive or a vessel containing adhesive. A brush retention member is provided wherein the brush retention member includes a body having a first end and a second end. The brush retention member includes a plurality of depressions formed in the upper surface thereof. In an alternative embodiment of the present invention the compartments and depressions are formed on a single body member. The present invention is preferably manufactured from silicone.

### FIELD OF THE INVENTION

The present invention relates generally to cosmetology accessories, more specifically but not by way of limitation, an apparatus configured to receive, retain and facilitate dispensing of materials such as but not limited to prosthetic glue and further provide retention of applicators such as but not limited to brushes.

### BACKGROUND

As is known in the art, in the art of filmmaking there is an extensive amount of preparation prior to capturing film that will be subsequently edited to create a desired film, commercial or similar output. One of the most extensive and time consuming preparations that is executed is wardrobe and make-up. Many times actors must spend hours with specially trained individuals that are involved in either fitting the actor for a special outfit or transforming the actors physical appearance through various make-up process. The latter can take many hours wherein an individual such as but not limited to a make-up artist will apply materials such as but not limited to makeup and prosthetics in order to achieve the desired appearance for the film.

The process of applying prosthetics and similar materials that provide significant physical alteration of the appearance of the actor typically requires the use of at least one adhesive. Adhesives and epoxies are designed to releasably secure prosthetics and other physical appearance altering elements to the skin of the actor. During the process make-up artists will employ at least one type of adhesive and will further utilize implements such as but not limited to brushes or spatulas to apply the adhesive in order to facilitate securing of the prosthetic. Makeup artists will often have a tray of material proximate to their location while working on an actor. The makeup artist will typically superpose adhesive containers and brushes directly onto the surface of the tray during use thereof. As brushes will accumulate glue matter thereon, placing them directly onto a surface is undesirable. Additionally, it is common to utilize temporary containers such as but not limited to cups wherein the cups are single use and further are not secure when solely placed on a support surface such as a counter or tray top.

Accordingly, there is a need for an adhesive and applicator holder wherein the adhesive and applicator holder are operable to provide retention of materials such as but not limited to glue and further provide an improved removal of any residual adhesive material for re-use of the adhesive and applicator holder.

### SUMMARY OF THE INVENTION

It is the object of the present invention to provide an adhesive and applicator holder configured to retain adhesives and applicators thereof wherein the present invention includes an adhesive retention member that is configured to receive and retain adhesive material in two compartments.

Another object of the present invention is to provide an adhesive and applicator apparatus configured to provide access to adhesive material during application thereof and further provide improved removal of residual adhesive after use wherein the two compartments of the adhesive retention member are further operable to receive adhesive containers therein.

A further object of the present invention is to provide an adhesive and applicator holder configured to retain adhesives and applicators thereof wherein the adhesive retention member of the present invention has a body manufactured from silicone or similar material in order to facilitate the release of adhesives therefrom.

Still another object of the present invention is to provide an adhesive and applicator apparatus configured to provide access to adhesive material during application thereof and further provide improved removal of residual adhesive after use wherein the brush retention member has a body that is elongated in shape having a plurality of depressions formed on the upper surface thereof.

An additional object of the present invention is to provide an adhesive and applicator holder configured to retain adhesives and applicators thereof wherein the compartments of the adhesive retention member are annular in shape.

Yet a further object of the present invention is to provide an adhesive and applicator apparatus configured to provide access to adhesive material during application thereof and further provide improved removal of residual adhesive after use wherein an alternative embodiment of the present invention includes the adhesive retention compartments combined on the same body member with the brush retention member.

Another object of the present invention is to a provide an adhesive and applicator holder configured to retain adhesives and applicators thereof wherein the alternative embodiment includes depressions in the upper surface being intermediate two compartments.

Still a further object of the present invention is to provide an adhesive and applicator apparatus configured to provide access to adhesive material during application thereof and further provide improved removal of residual adhesive after use that the compartments have rounded edges in order to facilitate improved removal of adhesive residue.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the adhesive retention member of the present invention; and

FIG. 2 is a perspective view of the brush retention member of the present invention; and

FIG. 3 is a perspective view of an alternative embodiment of the present invention.

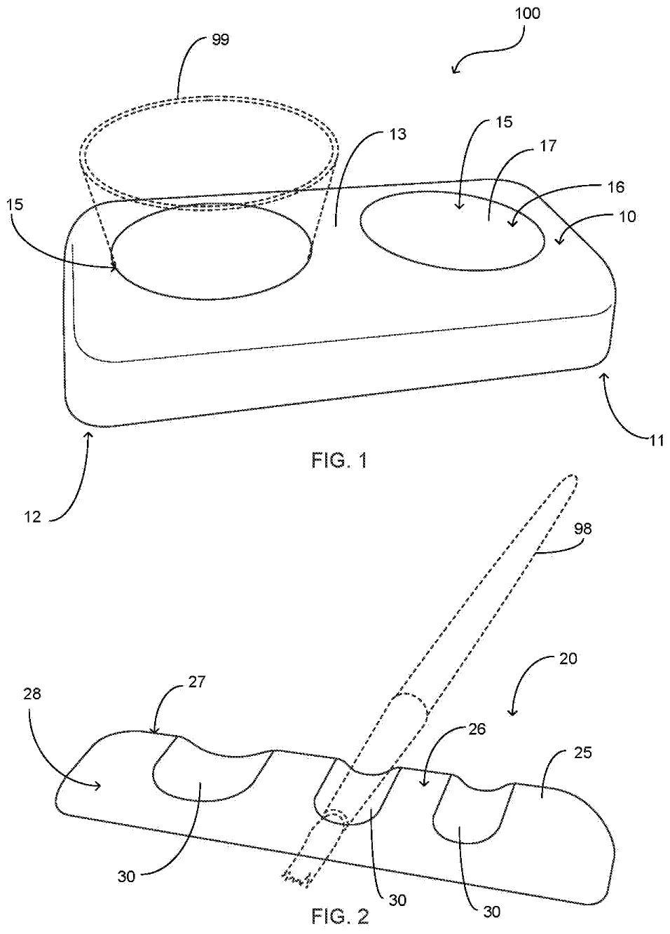

### DETAILED DESCRIPTION

Referring now to the drawings submitted herewith, wherein various elements depicted therein are not necessarily drawn to scale and wherein through the views and figures like elements are referenced with identical reference numerals, there is illustrated an adhesive and applicator holder 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the adhesive and applicator holder 100 includes an adhesive retention member 10. The adhesive retention member 10 is rectangular in shape having a first end 11 and a second end 12. While the preferred embodiment illustrated herein is rectangular in shape, it is contemplated within the scope of the present invention that the adhesive retention member 10 could be formed in alternate sizes and shapes. The adhesive retention member 10 includes compartments 15 formed in the upper surface 13 thereof. The compartments 15 include an opening 16 providing access to the interior volume 17. The compartments 15 are provided in a size so as to facilitate a first use and a second use.

In the first use, a user will deposit into the interior volume 17 a desired material such as but not limited to adhesive material. In a second use, a user will utilize the compartment 15 to releasably secure an exemplary cup 99 wherein the exemplary cup 99 is operable to receive and retain a desired material. The adhesive retention member 10 is manufactured from silicone in a preferred embodiment. Manufacturing the adhesive retention member 10 from silicon promotes the ability for a user to remove any residual adhesive material with ease due to the inherit properties of silicone. Additionally, the annular shape of the compartments 15 provide improved removal of any residual adhesive. While the compartments 15 are annular in the preferred embodiment, it should be understood within the scope of the present invention that the compartments 15 could be provided in alternate shapes and achieve the desired objectives discussed herein. The compartment 15 is sized however to mateably receive and secure therein a conventional 30 cc plastic cup in order to provide an alternate option for a user. The compartments 15 are axially aligned in order to provide a spacing and alignment thereof that is desirable when a user is using both compartments 15 for a two part material such as but not limited to a two part epoxy. It should be understood within the scope of the present invention that the while the preferred embodiment of the adhesive retention member 10 includes two compartments 15 more than two or less than two compartments 15 could be formed in the adhesive retention member 10.

The adhesive and applicator holder 100 includes a brush retention member 20 that is configured to secure an position implements such as but not limited to brushes 98. The brush retention member 20 includes a body 25 that is elongated and rectangular in shape. The body 25 includes an upper surface 26 wherein the upper surface 26 includes a plurality of depressions 30 formed therein. The depressions 30 are formed in the body 25 utilizing suitable durable techniques and are configured to receive an implement utilized for applying an adhesive material. The depressions 30 are provided having different widths in order to mateably receive a portion of alternate size implements. The depressions 30 extend intermediate the first side 27 and second side 28 of the body 25. This aforementioned formation of the depressions provides the ability to ensure releasably securing of the exemplary brush 98 within the depression 30. The brush retention member 20 is manufactured from silicone and while the embodiment illustrated herein illustrates three depressions, it is contemplated within the scope of the present invention that the body 25 could have more or less than three depressions 30 formed therein.

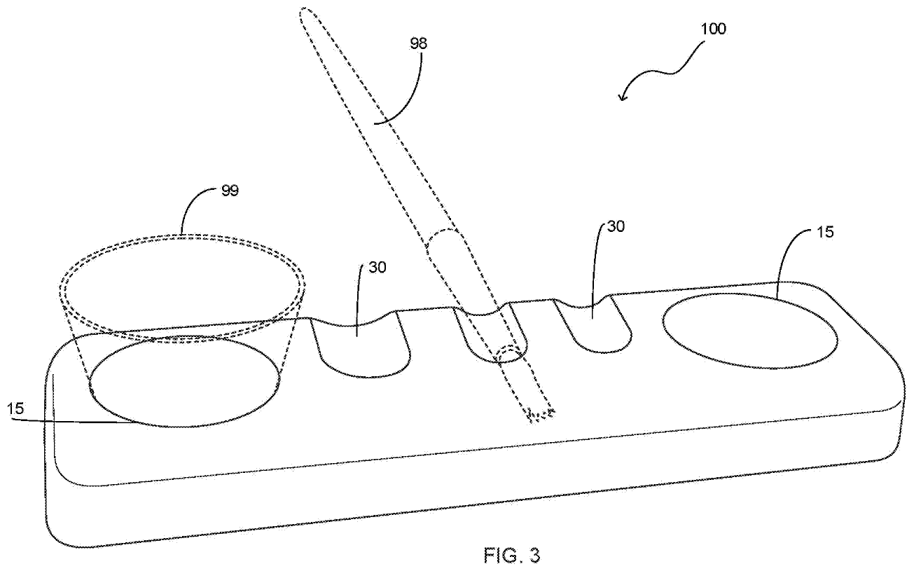

Illustrated herein in FIG. 3, the adhesive and applicator holder 100 is drawn in a preferred alternative embodiment wherein the adhesive retention member 10 and brush retention member 20 are formed as a single structure. In the alternative embodiment illustrated in FIG. 3, the adhesive and applicator holder 100 includes compartments proximate distal ends and having the depressions 30 present therebetween. It should be understood within the scope of the present invention that the alternative embodiment combining the adhesive retention member 10 and brush retention member 20 could employ alternate quantities and locations of compartments 15 and depressions. Furthermore it should be understood that the present invention could be utilized for materials other than adhesives.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A holder for a material and an applicator for the material wherein the holder comprises:
a first retention member, said first retention member having a first end and a second end, said first retention member having an upper surface, said first retention member having at least one compartment formed in the upper surface thereof, said at least one compartment having an interior volume, said at least one compartment having an opening proximate said upper surface providing access to said interior volume of at least one compartment; and
a second retention member, said second retention member having a body, said body of said second retention member having a first end and a second end, said body of said second retention member having an upper surface, said upper surface of said second retention member having at least one depression formed therein.

2. The holder for a material and an applicator as recited in claim 1, wherein said at least one compartment formed in the first retention member is annular in shape.

3. The holder for a material and an applicator as recited in claim 2, wherein the body of the second retention member includes a first side and a second side defining a width thereof.

4. The holder for a material and an applicator as recited in claim 3, wherein said at least one depression formed in the upper surface of said body of said second retention member extends between the first side and the second side.

5. The holder for a material and an applicator as recited in claim 4, wherein said first retention member is manufactured from silicone.

6. The holder for a material and an applicator as recited in claim 5, wherein said second retention member is manufactured from silicone.

7. An adhesive and applicator holder configured to store and receive adhesive providing accessibility thereto and further providing placement for the applicator holder wherein the adhesive and applicator holder comprises:
an adhesive retention member, said adhesive retention member having a first end and a second end, said first retention member having an upper surface, said first retention member having a first compartment and a second compartment formed in the upper surface thereof, said first compartment and a second compartment having an interior volume, said first compartment and a second compartment having an opening proximate said upper surface providing access to said interior volume of said first compartment and a second compartment; and
a brush retention member, said brush retention member having a body, said body of said brush retention member having a first end and a second end, said body of said brush retention member having an upper surface, said upper surface of said brush retention member having a plurality of depressions formed therein.

8. The adhesive and applicator holder as recited in claim 7, wherein said first compartment and said second compartment of said adhesive retention member are axially aligned intermediate said first end and said second end of said adhesive retention member.

9. The adhesive and applicator holder as recited in claim 8, wherein said first compartment and said second compartment are annular in shape.

10. The adhesive and applicator holder as recited in claim 9, wherein said body of said brush retention member includes a first side and a second side.

11. The adhesive and applicator holder as recited in claim 10, wherein said plurality of depressions of said brush retention member are adjacent each other on the upper surface of the body of the brush retention member and extend between the first side and second side.

12. The adhesive and applicator holder as recited in claim 11, wherein the adhesive retention member and brush retention member are manufactured from silicone.

13. An adhesive and applicator holder configured to store and receive adhesive providing accessibility thereto and further providing placement for the applicator holder wherein the adhesive and applicator holder comprises:
a body, said body having a first end and a second end, said body having an upper surface, said body having a first side and a second side defining a width of said body, said body having a first compartment, said first compartment having an interior volume and an opening providing access thereto, said first compartment being proximate said first end of said body, said body having a second compartment, said second compartment being proximate said second end of said body, said second compartment having an interior volume and an opening providing access thereto, said body further having a plurality of depressions, said plurality of depressions being formed on the upper surface of said body, said plurality of depressions extending between said first side and said second side of said body, said plurality of depressions being axially aligned with said first compartment and said second compartment.

14. The adhesive and applicator holder as recited in claim 13, wherein said first compartment and said second compartment are annular in shape.

15. The adhesive and applicator holder as recited in claim 14, wherein said body is manufactured from silicone.
